(19) United States
(12) Patent Application Publication
(10) Pub. No.: US 2005/0080218 A1
(43) Pub. Date: Apr. 14, 2005

(54) Highly flame-resistant polyurethane adhesives

(76) Inventors: Lothar Thiele, Langenfeld (DE); Andre te Poel, Willich (DE); Helga Garmann, Leverkusen (DE); Marion Gorzny, Duesseldorf (DE); Francois Sanch, Paris (FR)

Correspondence Address: HENKEL CORPORATION, THE TRIAD, SUITE 200, 2200 RENAISSANCE BLVD., GULPH MILLS, PA, 19406, US

(21) Appl. No.: 10/869,398

(22) Filed: Jun. 16, 2004

Related U.S. Application Data
(63) Continuation of application No. PCT/EP02/13987, filed on Dec. 10, 2002.

(30) Foreign Application Priority Data
Dec. 18, 2001 (DE) 101 62 344.5

(51) Int. Cl. C08G 18/00

(52) U.S. Cl. 528/44

(57) ABSTRACT

Reactive polyurethane adhesive compositions are provided which contain one or more polyols, one or more polyisocyanates, and one or more fillers and which have specific caloric values according to EN ISO 1716 of not more than 20 MJ/kg.

### CROSS-REFERENCE TO RELATED APPLICATIONS

This application is a continuation under 35 USC Sections 365(c) and 120 of International Application No. PCT/EP02/13987 filed 10 Dec. 2002 and published 26 Jun. 2003 as WO 03/051954, which claims priority from German Application No. 10162344.5, filed 18 Dec. 2001, each of which is incorporated herein by reference in its entirety.

### FIELD OF THE INVENTION

This invention relates to flame-retardant reactive polyurethane adhesives and to their use for the production of structural elements.

### BACKGROUND OF THE INVENTION

In the construction industry, active fire protection is assuming an increasingly more important role. Many interior finishing elements in the construction industry and also structural elements for the fitting out of ships consist of sandwich elements of which the core is made of mineral wool and which comprise metal outer layers.

Foaming adhesives are the preferred products for the production of such sandwich elements of mineral wool and metal cover layers by virtue of their favorable adhesive properties through the consolidation of the mineral wool by the foam formed and its penetration into the mineral wool. The polyurethane adhesive can be foamed with isocyanate and water or with isocyanate and carboxylic acids.

In cases where the panels are expected to meet stringent requirements in regard to fire protection and low smoke emission in the event of fire, filler-containing polyurethane systems are advantageous by virtue of their low calorific value. These products have high viscosities so that they can only be sprayed to a limited extent, if at all. Spray application of the adhesives is essential because the fire protection panels are generally produced by the DBL process (double belt lamination).

Flameproofed isocyanate-based rigid foams, more particularly polyurethane and polyisocyanurate rigid foams, have been known for some time and are mainly used for insulation purposes in the construction industry. Halogen-free formulations for flameproofed isocyanate-based rigid foams are known from DE-A-4003718, DE-A-4109076, DE-A-4222519 and EP-B-0463493. These formulations contain phosphoric acid esters, such as diphenyl cresyl phosphate and triethyl phosphate for example, or phosphonic acid esters, such as diethyl ethyl phosphonate and dimethyl methyl phosphonate for example, in relatively large quantities as flameproofing agents. These flameproofing agents adversely affect mechanical strengths and ageing behavior. In addition, halogen-free formulations of flameproofed isocyanate-based rigid foams are described in DE-A-4020283, red phosphorus being used as the flameproofing agent. Red phosphorus tends to ignite, particularly on exposure to the heat of friction generated by mechanically moved parts, such as occurs, for example, in polyurethane or sandwich processing plants. Accordingly, there are safety-related objections to the use of red phosphorus. Corresponding additions of flameproofing agents are not applicable to low-viscosity reactive polyurethane adhesives applied by spraying. Even the addition of diluents or other viscosity-reducing additives does not lead to usable adhesives.

EP-A-719807 discloses a process for the production of flameproofed isocyanate-based rigid foams, more particularly rigid polyurethane and polyisocyanurate foams, by reaction of organic and/or modified organic polyisocyanates with at least one relatively high molecular weight compound containing at least two reactive hydrogen atoms and optionally low molecular weight chain-extending and/or crosslinking gents in the presence of blowing agents, catalysts, flameproofing agents and optionally other auxiliaries and/or additives, the flameproofing agent being a combination of at least one liquid isocyanate-reactive flameproofing agent and at least one solid flameproofing agent. It is not apparent from the document in question whether such a process is also suitable for the production of flame-retardant, low-smoke adhesives for the production of sandwich elements.

EP-A-913415 teaches that the addition of carbohydrate components, such as starch or sugar in finely ground form, improves the long-term flameproofing of rigid polyurethane foams. Again, it is not apparent from this document whether such measures are suitable for the production of adhesives that are suitable for the production of sandwich elements;

To reduce the smoking of polyurethane adhesives, EP-A-876415 proposes the use of a high percentage of water (at least 5% by weight, based on the total quantity of adhesive) in the polyol component. However, this adhesive can only be used in coating weights below 150 g/m² to ensure satisfactorily low smoke emission and acceptable burning behavior and to meet the requirements of DIN 4102, Class A2. However, although such small applications of adhesive may be acceptable for nonporous substrates, they are not suitable for permanently bonding porous materials, such as mineral wool, firmly to other substrates.

In light of this prior art, the problem addressed by the present invention was to provide foaming adhesives with good adhesive properties which would be suitable for the bonding and consolidation of mineral wool with metal outer layers; the bonded sandwich element would meet the A2 classification of EN 13501-1 and/or DIN 4102, Part 1.

### BRIEF SUMMARY OF THE INVENTION

The present invention provides polyurethane adhesive compositions based on polyols, polyisocyanates and fillers which have a specific calorific value of or below 20 MJ/kg and preferably of or below 15 MJ/kg.

The present invention also relates to the use of the above-mentioned compositions for bonding sandwich elements, more particularly for bonding shaped bodies of mineral wool to metal outer layers.

### DETAILED DESCRIPTION OF CERTAIN EMBODIMENTS OF THE INVENTION

Although the polyurethane adhesives according to the invention may also be formulated as one-component moisture-reactive adhesives, the preferred formulation is a two-component foaming adhesive in which component A contains one or more polyols, flame-retardant fillers, optionally plasticizers and high-boiling solvents, small quantities of water and/or carboxylic acid(s) and/or wetting agents.

In principle, suitable polyols are any difunctional or trifunctional polyols known in polyurethane chemistry such as, for example, polyethylene glycols, polypropylene glycols, polytetraethylene glycols, polybutylene glycols and/or copolymers thereof and polyester polyols based on aliphatic or aromatic dicarboxylic acids and low molecular weight diols or triols. Hydroxyfunctional polycaprolactones may also be used. The known difunctional or trifunctional polyols mentioned above or mixtures thereof have molecular weights (MW) of 300 to 5,000 and preferably in the range from 400 to 2,000. Polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkyl ester polyols with 1 to 12 carbon atoms in the alkyl group (see, for example, DE-A-3626223). Other suitable polyols are the esterification products of dimer fatty acid and low molecular weight diols and/or triols known as dimer diols or triols (such as those available from Cognis Corporation).

In one particular embodiment, however, castor oil is used as the main component of the polyol so that smoke emission is drastically reduced. Instead of castor oil emanating from natural sources, the transesterification products of mixtures of castor oil and native, substantially OH-free triglycerides, such as rapeseed oil, sunflower oil, oil of new sunflowers, soya oil or mixtures thereof, disclosed in DE-A-19947563 may also be used. The teaching of DE-A-19947563 in regard to the polyurethane binder components is expressly part of the present application.

Component B generally contains only one polyisocyanate which has an isocyanate functionality of 2.0 to 3.0 and preferably in the range from 2.0 to 2.7. In principle, any aromatic, cycloaliphatic or aliphatic polyisocyanate may be used as the hardener component B.

Examples of suitable aromatic polyisocyanates are: any isomers of toluene diisocyanate (TDI) either in the form of the pure isomer or as a mixture of several isomers, naphthalene-1,5-diisocyanate (NDI), naphthalene-1,4-diisocyanate (NDI), diphenylmethane-4,4′-diisocyanate (MDI), diphenylmethane-2,4′-diisocyanate and mixtures of 4,4′-diphenylmethane diisocyanate with the 2,4′-isomer or mixtures thereof with oligomers of relatively high functionality (so-called crude MDI), xylylene diisocyanate (XDI), 4,4′-diphenyl dimethyl methane diisocyanate, di- and tetraalkyl diphenyl methane diisocyanate, 4,4′-dibenzyl diisocyanate, 1,3-phenylene diisocyanate, 1,4-phenylene diisocyanate. Examples of suitable cycloaliphatic polyisocyanates are the hydrogenation products of the above-mentioned aromatic diisocyanates such as, for example, 4,4′-dicyclohexyl methane diisocyanate (H₁₂MDI or HMDI), 1-isocyanatomethyl-3-isocyanato-1,5,5-trimethyl cyclohexane (isophorone diisocyanate, IPDI), cyclohexane-1,4-diisocyanate, hydrogenated xylylene diisocyanate (H₆XDI), 1-methyl-1,4-diisocyanatocyclohexane, 1,4-diisocyanato-2,2,6-trimethyl cyclohexane (TMCDI), m- or p-tetramethyl xylylene diisocyanate (m-TMXDI, p-TMXDI) and dimer fatty acid diisocyanate. Examples of aliphatic polyisocyanates are tetramethoxybutane-1,4-diisocyanate, butane-1,4-diisocyanate, hexane-1,6-diisocyanate (HDI), 1,6-diisocyanato-2,2,4-trimethylhexane, 1,6-diisocyanato-2,4,4-trimethylhexane and 1,12-dodecane diisocyanate (C₁₂DI). Homologous mixtures of crude 4,4′-diphenylmethane diisocyanate are most particularly preferred—also and above all for reasons of cost.

In order to obtain a low specific calorific value according to EN ISO 1716 of or below 20 MJ/kg, it is important that the fillers are carefully selected. Preferred fillers are kaolin, calcium oxide/calcium carbonate, magnesium carbonate, calcium magnesium carbonate, basic magnesium carbonates, zinc borate, antimony oxide, ammonium phosphate, aluminum hydroxide, hydrated aluminum oxide or mixtures thereof, aluminum hydroxide or hydrated aluminum oxide being particularly preferred as the predominant constituent of the filler combination. A further improvement in the flame-retardant effect, in the low specific calorific value and in minimal smoke emission is achieved by the addition of halogenated organic compounds and/or organic phosphorus compounds.

The halogenated organic compounds may be selected from chloroparaffins, hexabromobenzene, brominated diphenylethers-, dibromoneopentyl glycol (as an isocyanate-reactive flame-retardant component) and PVC powder or mixtures of the halogenated organic compounds mentioned above.

The organic phosphorus compounds may be selected from triaryl phosphates, more particularly triphenyl phosphate, tricresyl phosphate, alkyl aryl phosphates, alkyl phosphites, aryl phosphites, alkylaryl phosphites, the corresponding phosphonates or mixtures of the above-mentioned phosphorus compounds. Actual examples are tris-(isopropylated phenyl)-phosphate, trixylyl phosphate, tritoluyl phosphate, 2-ethylhexyl diphenyl phosphate, decyl diphenyl phosphate, tris-(2-chloroethyl)-phosphate, tris-(2-chloropropyl)-phosphate, tris-(2,3-dibromopropyl)-phosphate, tetrakis-(2-chloro)-ethylene diphosphate, dimethyl methyl phosphonate, diethyl ethyl phosphonate and mixtures thereof.

Besides the above-mentioned (halogen-substituted) phosphates, other (in)organic flameproofing agents, such as for example arsenic oxide, expanded graphite, calcium sulfate, cyanuric acid derivatives, such as melamine for example, coated red phosphorus and—as synergists—metal salts based on molybdates, borates, stannates or mixtures of at least two flameproofing agents, for example ammonium polyphosphates and melamine and/or expanded graphite, may be used in accordance with the invention.

To reduce viscosity, the adhesive compositions according to the invention may also contain high-boiling solvents, more particularly lower alkyl esters of C₄₋₈ dicarboxylic acids. Mixtures of dicarboxylic acid methyl esters are particularly preferred.

In general, it has proved to be appropriate to use 5 to 50 parts by weight and preferably 10 to 25 parts by weight of the above-mentioned flameproof agents or mixtures to 100 parts by weight of component A.

It was mentioned at the beginning that a preferred embodiment of the adhesives is intended to foam after application. In this case, component A (the polyol component) contains small quantities of water and/or carboxylic acid(s) of the order of 0.1 to 1% by weight and preferably up to 0.5% by weight of water or carboxylic acid(s), based on component A.

In addition, typical rheology aids, such as in particular highly disperse silicas, and other typical auxiliaries and additives in small amounts, such as wetting agents and dispersants, pigments, antiagers and typical polyurethane catalysts, may be used.

It has already been pointed out that, in a preferred embodiment, the adhesives according to the invention are formulated as two-component adhesives, component A containing the polyols, the flame-retardant fillers and the other flame retardants and smoke trappers and also water and/or carboxylic acid(s), rheology aids, wetting agents and other auxiliaries and additives and component B generally containing only the polyisocyanate, preferably crude MDI. The mixing ratio of components A to B is 100:20±5 ratio by weight).

The following Examples are intended to illustrate the invention without limiting its scope in any way. Unless otherwise stated, all quantities in the following Examples are percentages by weight or parts by weight, based on the overall composition of polyol-containing component A.

### EXAMPLES

The following adhesive formulations were prepared by homogenizing the A components (polyol-containing components). The polyol/hardener mixtures were then prepared in the mixing ratios indicated and cured. The specific calorific value was then determined to EN ISO 1716.

### Example 1 (Comparison)

| | |
|---|---|
| difunctional polypropylene glycol MW 1000 | 9.2% |
| trifunctional polypropylene glycol MW 750 | 6.1% |
| trifunctional polypropylene glycol MW 450 | 8.0% |
| dispersant (BYK W 968) | 1.0% |
| mixture of dicarboxylic acid methyl esters | 3.0% |
| water | 0.4% |
| AEROSIL 150 silica | 0.3% |
| chalk | 72.0% |
| hardener: crude MDI, | |
| mixing ratio (resin:hardener) = 100:20 (weight) | |

### Example 2 (Invention)

| | |
|---|---|
| castor oil | 15.3% |
| trifunctional polypropylene glycol MW 450 | 8.0% |
| dispersant (BYK W 968) | 1.0% |
| mixture of dicarboxylic acid methyl esters | 3.0% |
| water | 0.4% |
| AEROSIL 150 silica | 0.3% |
| aluminum hydroxide | 72.0% |
| hardener: crude MDI, | |
| mixing ratio (resin:hardener) = 100:20 (weight) | |

### Example 3 (Invention)

| | |
|---|---|
| castor oil | 10.3% |
| trifunctional polypropylene glycol MW 450 | 8.0% |
| dispersant (BYK W 968) | 1.0% |
| mixture of dicarboxylic acid methyl esters | 3.0% |
| diethoxy ethyl phosphine oxide | 5.0% |
| water | 0.4% |
| AEROSIL 150 silica | 0.3% |
| zinc borate | 4.0% |
| aluminum hydroxide | 68.0% |
| hardener: crude MDI, | |
| mixing ratio (resin:hardener) = 100:25 (weight) | |

For Example 1, a value of 20 MJ/kg was determined, so that applications of the adhesive of up to 200 g/m² are possible to achieve the standards of EN 13501-1 for non-substantial panel constituents (sandwich constituents), such as the adhesive, in the case of non-homogeneous structural elements. This Standard requires a specific calorific value of the non-substantial constituents, such as the adhesive, of less than 4 MJ/m². However, in view of the small applications of adhesive, the sandwich bonds produced with this adhesive have relatively low strengths and, in addition, show such heavy smoke emission in the SBI Test (Single Burning Item Test, EN 13823) that they failed the test. The SBI Test including smoke emission is the second criterion (besides the specific calorific value) which an adhesive has to meet according to EN 13501-1. By partly replacing the polypropylene glycols with castor oil, smoke emission can surprisingly be greatly reduced and, by using aluminum hydroxide instead of calcium carbonate, the specific calorific value is drastically reduced. The adhesive according to Example 2 (invention) has a specific calorific value of 12 MJ/kg. The adhesive may thus be applied in a maximum quantity of 333 g/m² so that sandwich bonds thus produced have greater strengths. In addition, sandwich bonds of mineral wool panels and metal outer layers meet the requirements for the A2 classification of EN 13501-1.

DIN 4012-1, which is still widely used for fire protection classification, lays down even stricter standards in regard to smoke emission on exposure to a flame or under carbonization conditions and in the fire tube test which the adhesive of Example 2 does not yet meet.

Adhesive 3 according to the invention has the same calorific value as the adhesive of Example 2. By virtue of the additional flameproofing agents, this adhesive satisfies all the requirements it has to meet to ensure that adhesive bonds of the above-mentioned type also fulfil DIN 4102-1. The bonds also pass the fire tube test.

1. A reactive polyurethane adhesive composition comprising one or more polyols, one or more polyisocyanates and one or more fillers and having a specific calorific value according to EN ISO 1716 of ≦20 MJ/kg.

2. A reactive polyurethane adhesive composition as claimed in claim 1 consisting of a component A which comprises one or more polyols and one or more flame-retardant fillers, and a component B which comprises a polyisocyanate having an isocyanate functionality of 2.0 to 3.0.

3. A reactive polyurethane adhesive composition as claimed in claim 2, wherein component A additionally comprises one or more OH-functional triglycerides.

4. A reactive polyurethane adhesive composition as claimed in claim 2, wherein the flame-retardant additives are selected from the group consisting of kaolin, calcium oxide, calcium carbonate, magnesium carbonate, calcium magnesium carbonate, basic magnesium carbonates, zinc borate, antimony oxide, aluminum hydroxide, hydrated aluminum oxide, ammonium polyphosphate and mixtures thereof.

5. A reactive polyurethane adhesive composition as claimed in claim 4, additionally comprising one or more halogenated organic compounds.

6. A reactive polyurethane adhesive composition as claimed in claim 5, wherein the halogenated organic compounds are selected from the group consisting of chloroparaffins, hexabromobenzene, brominated diphenyl ester, dibromoneopentyl glycol, PVC and mixtures thereof.

7. A reactive polyurethane adhesive composition as claimed in claim 4, additionally comprising one or more organic phosphorus compounds.

8. A reactive polyurethane adhesive composition as claimed in claim 7, wherein the organic phosphorus compounds are selected from the group consisting of triaryl phosphates, akyl aryl phosphates, trialkyl phosphates, aryl, alkylaryl and alkyl phosphites and phosphonates and mixtures thereof.

9. A reactive polyurethane adhesive composition as claimed in claim 2, wherein component A additionally comprises at least one foaming agent selected from the group consisting of water and carboxylic acids.

10. A reactive polyurethane adhesive composition as claimed in claim 2, wherein component A additionally comprises at least one high-boiling solvent.

11. A reactive polyurethane adhesive composition as claimed in claim 2, wherein component A additionally comprises at least one rheology aid.

12. A reactive polyurethane adhesive composition as claimed in claim 2, wherein component A comprises at least one OH-functional triglyceride selected from the group consisting of castor oil and transesterification products of mixtures of caster oil with triglycerides free from OH groups.

13. A reactive polyurethane adhesive composition as claimed in claim 2, wherein component B comprises at least one aromatic polyisocyanate selected from the group consisting of diphenylmethane-4,4′-diisocyanate, diphenylmethane2,4′-diisocyanate and oligomers and mixtures thereof.

14. A reactive polyurethane adhesive composition as claimed in claim 1, wherein at least one filler is selected from the group consisting of aluminum hydroxide and hydrated aluminum hydroxide.

15. A method of bonding a first sandwich element and a second sandwich element using an adhesive, said method comprising using a reactive polyurethane composition as claimed in claim 1 as the adhesive.

16. A method as claimed in claim 15, wherein the first sandwich element is comprised of mineral wool and the second sandwich element is comprised of metal.

17. A method as claimed in claim 15, wherein the reactive polyurethane adhesive composition is foamed.

18. A method as claimed in claim 15, wherein the reactive polyurethane adhesive composition consists of a component A which comprises one or more polyols and one or more flame-retardant fillers, and a component B which comprises a polyisocyanate having an isocyanate functionality of 2.0 to 3.0.

19. A structural element comprising two metal outer layers and a core comprised of mineral wool sandwiched between the two metal outer layers, wherein a reactive polyurethane adhesive composition as claimed in claim 1 in cured and foamed form is penetrated into the core and bonds the two metal outer layers to the core.

20. A structural element as claimed in claim 19 having a burning behaviour corresponding to at least one of class A2 of EN 13501-1 and DIN 4102, Part 1.
